(19) United States
(12) Patent Application Publication
(10) Pub. No.: US 2012/0110483 A1
(43) Pub. Date: May 3, 2012

(54) MULTI-DESKTOP MANAGEMENT

(75) Inventors: Mauro Arcese, Rome (IT); Luca Gimondo, Rome (IT); Marco Imperia, Rome (IT); Stefano Manocchio, Anguillara Sabazia (IT)

(73) Assignee: INTERNATIONAL BUSINESS MACHINES CORPORATION, Armonk, NY (US)

(21) Appl. No.: 13/277,049

(22) Filed: Oct. 19, 2011

(30) Foreign Application Priority Data
Oct. 27, 2010 (EP) 10189087.9

(51) Int. Cl. G06F 3/048

(52) U.S. Cl. 715/768

(57) ABSTRACT

A transparency percentage value is associated with each application icon defined for active executable applications using a computing system. At least one application that is active on a desktop screen is collected for each of at least two different visual attribute values collected from a user. The different collected visual attribute values are displayed with a pointing widget. The icons of the applications are displayed using a transparency percentage value of zero percent (0%) for icons corresponding to the visual attribute value currently pointed to and a transparency percentage value of one hundred percent (100%) for any other icon that is not currently pointed to. In response to detecting a change by the user from a current visual attribute value to a different new visual attribute value pointed to by the pointing widget, the transparency percentage values of the application icons are adjusted based upon the new visual attribute value.

### RELATED APPLICATIONS

This application claims priority to and claims the benefit of European Patent Application Serial No. 10189087.9 titled “A METHOD, COMPUTER PROGRAM AND SYSTEM FOR MULTI-DESKTOP MANAGEMENT,” which was filed in the European Patent Office on Oct. 27, 2010, and which is incorporated herein by reference in its entirety.

### BACKGROUND

This invention generally relates to operating system graphical user interfaces and windowing. More particularly, the invention aims at improving management of application icons through a desktop application.

Most modern personal computer or portable intelligent device operating systems today provide a desktop environment that allows a user to manage his/her activity on the computer by interfacing graphically with the operating system (OS) through a keyboard and/or pointing devices. Even if the traditional command-line interface is still used for full control over the OS, a desktop application is useful to organize and realize the general tasks realized in an office. Using icons, windows, toolbars, folders, wallpapers, shortcuts, widgets, and drag and drop functions, the desktop environment is intuitive for the user and improves the user's productivity.

### BRIEF SUMMARY

The present subject matter provides a method, system, and computer program product for facilitating access to applications visualized by icons on multiple desktops corresponding to multiple groups of applications provided through the operating system graphical interface of a computer or any intelligent device.

Thus, in accord with certain implementations, a method involves associating, via a computing system, a transparency percentage value with each application icon defined for active executable applications; collecting from a user at least two differentiating visual attribute values and collecting, for each different visual attribute value, at least one application that is active on a desktop screen; displaying the different collected visual attribute values and a pointing widget that allows the user to designate one of the different visual attribute values; displaying the icons of the at least one application collected for each different visual attribute value using a transparency percentage value of zero percent (0%) for each application icon of the at least one application corresponding to the visual attribute value currently pointed to by the pointing widget and a transparency percentage value of one hundred percent (100%) for at least one other application icon corresponding to at least one visual attribute value that is not currently pointed to by the pointing widget; and, in response to detecting a change by the user of a current visual attribute value pointed to by the pointing widget to a different new visual attribute value pointed to by the pointing widget, adjusting the transparency percentage values of the application icons based upon the new visual attribute value pointed to by the pointing widget.

In certain implementations, the visual attribute values are colors and the pointing widget is a scrollbar thumb moving in a scrollbar, and the method of collecting from the user the at least two differentiating visual attribute values and collecting, for each different visual attribute value, the at least one application that is active on the desktop screen involves collecting from the user at least two colors and collecting, for each color, at least one applications that is active on the desktop screen; the method of displaying the different collected visual attribute values and the pointing widget that allows the user to designate the one of the different visual attribute values involves displaying the scrollbar in which colored areas correspond to the at least two collected colors, where the user can move the scrollbar thumb relative to the scrollbar; the method of displaying the icons of the at least one application collected for each different visual attribute value using the transparency percentage value of zero percent (0%) for each application icon of the at least one application corresponding to the visual attribute value currently pointed to by the pointing widget and the transparency percentage value of one hundred percent (100%) for the at least one other application icon corresponding to the at least one visual attribute value that is not currently pointed to by the pointing widget involves displaying the icons of the of the at least one application collected for each different color using the transparency percentage value of zero percent (0%) for each application icon of the at least one application corresponding to the color of the colored area currently pointed to by the scrollbar thumb in the scrollbar and the transparency percentage value of one hundred percent (100%) for the at least one other application icon corresponding to at least one color that is not currently pointed to by the scrollbar thumb; and the method of, in response to detecting the change by the user from the current visual attribute value pointed to by the pointing widget to the different new visual attribute value pointed to by the pointing widget, adjusting the transparency percentage values of the application icons based upon the new visual attribute value pointed to by the pointing widget involves, in response to detecting a move by the user of the scrollbar thumb in the scrollbar into one different colored area, adjusting the transparency percentage values of the application icons based upon the new color pointed to by the scrollbar thumb.

In certain implementations, the method of displaying the icons of the at least one application collected for each different color involves displaying at one edge of the desktop screen a desktop taskbar within a desktop environment; and displaying in the desktop taskbar the icons of the at least one application collected for each different color that are currently running using the transparency percentage value of zero percent (0%) for each application of the at least one application corresponding to the color of the colored area pointed to by the scrollbar thumb in the scrollbar and the transparency percentage value of one hundred percent (100%) for the at least one other application icon corresponding to at least one color that is not currently pointed to by the scrollbar thumb.

In certain implementations, the method further involves displaying, in response to detecting the user starting the execution of an application by clicking on an icon that corresponds to the started application among the icons displayed for the at least one application corresponding to the color of the colored area pointed t0 by the scrollbar thumb in the scrollbar, in the desktop taskbar the icon that corresponds to the started application with the transparency percentage value of zero percent (0%).

In certain implementations, the method of collecting from the user the at least two colors is replaced by automatically computing a prevailing color of each icon defined for the at least one application that is active on the desktop screen; and forming for each computed prevailing color, a set of at least one application with icons that include the computed prevailing color.

In certain implementations, the method further involves activating an application in response to detection of the user clicking on an application icon only if the application icon is displayed with a transparency percentage value not greater than a maximum configuration percentage value represented by a variable “m” percent (m %), “m” being greater than zero.

In certain implementations, the transparency percentage value of zero percent (0%) is accepted to be not greater than a constant configuration percentage value of “k” percent (k %) and the transparency percentage value of one hundred percent (100%) is accepted to be equal to or not greater than a constant configuration parameter percentage value of (100-k) %.

In certain implementations, the transparency percentage values applied to the application icons when the user moves the scrollbar thumb from a first point (p1) of a color palette in the scrollbar to a second point (p2) of the color palette in the scrollbar depends on a physical distance d(p1,p2) in the scrollbar between the two points.

In certain implementations, the transparency percentage values applied to application icons of applications associated with the second point (p2) of the color palette in the scrollbar when the user moves the cursor from the first point (p1) to the second point (p2) in the scrollbar includes:

Tp2=(d(p1,p2)/C)*100, when d(p1,p2)>c and

Tp2=100 when d(p1,p2)> or =c;

c being a constant configuration value.

In certain implementations, the scrollbar contains a color palette and the scrollbar thumb includes a cursor.

In another implementation, a system includes means adapted to carry out the steps of associating, via a computing system, a transparency percentage value with each application icon defined for active executable applications; collecting from a user at least two differentiating visual attribute values and collecting, for each different visual attribute value, at least one application that is active on a desktop screen; displaying the different collected visual attribute values and a pointing widget that allows the user to designate one of the different visual attribute values; displaying the icons of the at least one application collected for each different visual attribute value using a transparency percentage value of zero percent (0%) for each application icon of the at least one application corresponding to the visual attribute value currently pointed to by the pointing widget and a transparency percentage value of one hundred percent (100%) for at least one other application icon corresponding to at least one visual attribute value that is not currently pointed to by the pointing widget; and, in response to detecting a change by the user of a current visual attribute value pointed to by the pointing widget to a different new visual attribute value pointed to by the pointing widget, adjusting the transparency percentage values of the application icons based upon the new visual attribute value pointed to by the pointing widget.

In another implementation, a computer program product includes stored instructions, that when executed on a computer, carry out the steps of associating, via a computing system, a transparency percentage value with each application icon defined for active executable applications; collecting from a user at least two differentiating visual attribute values and collecting, for each different visual attribute value, at least one application that is active on a desktop screen; displaying the different collected visual attribute values and a pointing widget that allows the user to designate one of the different visual attribute values; displaying the icons of the at least one application collected for each different visual attribute value using a transparency percentage value of zero percent (0%) for each application icon of the at least one application corresponding to the visual attribute value currently pointed to by the pointing widget and a transparency percentage value of one hundred percent (100%) for at least one other application icon corresponding to at least one visual attribute value that is not currently pointed to by the pointing widget; and, in response to detecting a change by the user of a current visual attribute value pointed to by the pointing widget to a different new visual attribute value pointed to by the pointing widget, adjusting the transparency percentage values of the application icons based upon the new visual attribute value pointed to by the pointing widget.

### BRIEF DESCRIPTION OF THE SEVERAL VIEWS OF THE DRAWINGS

FIG. 1 illustrates an environment of an example of an implementation of the present subject matter and illustrates software blocks in a computer in which the present subject matter may be implemented as a new software layer;

FIG. 2 is a flowchart of an example of an implementation of a process for implementing a user interface according to the present subject matter;

FIG. 3 shows one static view of an example of an implementation of a desktop according to the present subject matter;

FIG. 4 illustrates an example of an implementation of the continuous desktop display in line with the movement of the cursor in the scrollbar according to the present subject matter;

FIG. 5 is a general flowchart of an example of an implementation of a process that implements the present subject matter; and

FIG. 6 illustrates one example of an implementation of computation for a progressive change of percentage of transparency applied to the application icons according to the present subject matter.

### DETAILED DESCRIPTION

The present subject matter allows, by the use of a move of a cursor in a toolbar, a smooth and more productive switching from one group of applications to another group of applications. The use of color codes inside a toolbar facilitates the different desktop identification of application groups and provides a more global view of an entire user working environment. By the use of a transparency effect, the switching from one desktop to another desktop may be performed continuously. Techniques, such as alpha composing, for making a displayed object opaque or transparent, may be applied to the application icons in the multiple desktop views and in the associated toolbar of running applications. The change of percentage of transparency, which is performed at the pixel level, may be performed at the level of an object when these algorithms are implemented by an operating system. The change of percentage of transparency applied to the application icons may be adjusted progressively while the user moves the cursor. If the user moves the cursor in a color palette, the present subject matter allows obtaining an “infinite” number of desktops. Instead of assigning each icon application to a specific desktop, with the present subject matter the user may assign colors to the application icons or use the initial colors. Ideally, the same icon may be shown in different views of the same desktop.

With the present subject matter, the desktop view is changed while a same desktop is kept, and the applications icons may be maintained in the same position in the desktop view.

To perform the continuous change in the desktop views, the percentage of transparency applied to the application icons is progressively changed. The percentage of transparency of the currently pointed color in the scrollbar switches progressively from zero percent (0%) to one hundred percent (100%) while the percentage of transparency of the new pointed color in the scrollbar switches progressively from one hundred percent (100%) to zero percent (0%). This means that the application icons of the currently pointed color progressively disappear while the application icons of the new pointed color progressively appear.

The present subject matter is flexible enough to be used with many different graphical environments. The scrollbar may be replaced by any other pointing widget that the user may move, such as a knob for instance. Also, the scrollbar may be permanently displayed or displaying may be activated by the user clicking on a tab whenever the user wants to change the desktop. The use of color is also optional and any visual attribute for which the user may change the value is possible, such as a knob that may point to different visual graphical signs instead of a different color. The use of color is preferred because a default color value may be calculated by the computer choosing an application icon prevailing color. Also the use of color allows using a color palette that is not limited by a number of desktops.

Conception of the present subject matter resulted from recognition of certain limitations associated with desktop applications. For example, with a desktop application, the user may represent one application by an icon on which he/she clicks with his pointing device to start its execution. Alternatively, a group of application icons may also be displayed onto a graphic toolbar, called the taskbar. The desktop window may display a reasonable number of application icons corresponding to the usual tasks realized in an office. However, for specialized users such as software developers who access different application environments during their working day, the desktop window is too crowded and it becomes difficult to identify each application icon. For instance, a software developer may access applications in relation with the development framework as testing applications, graphical and text editors, a software repository manager, and project databases. The same developer may also access collaboration tools for mails, agenda, as well as the Internet world through a browser. It was observed that in this situation, there is a need for classifying the numerous applications accessed during the day to alleviate the problem of real estate limitations on the desktop window. It was additionally observed that one known solution consists in managing multiple desktops with each desktop view corresponding to a specific working environment and a group of applications. A system and method is disclosed in the US patent application US 2003/0179240 for managing virtual desktops in a windowing environment. This solution allows the user to navigate between different virtual desktops with each virtual desktop corresponding to a logical state. A three dimensional geometric widget is used to switch between virtual desktops. It was further observed that within the existing solutions, a sequence of gestures (function keys, mouse clicking) is necessary for switching from one desktop to other one and it is not so easy for the user to remember all the desktop views. Further, it was observed that within the existing solutions, the user does not have a global view of all his/her activities by desktop groups of applications.

In contrast to the existing multidesktop management solutions, the present subject matter improves the way users navigate through different specialized desktops. The present subject matter provides users with a global view of all of his/her activities by desktop groups of applications.

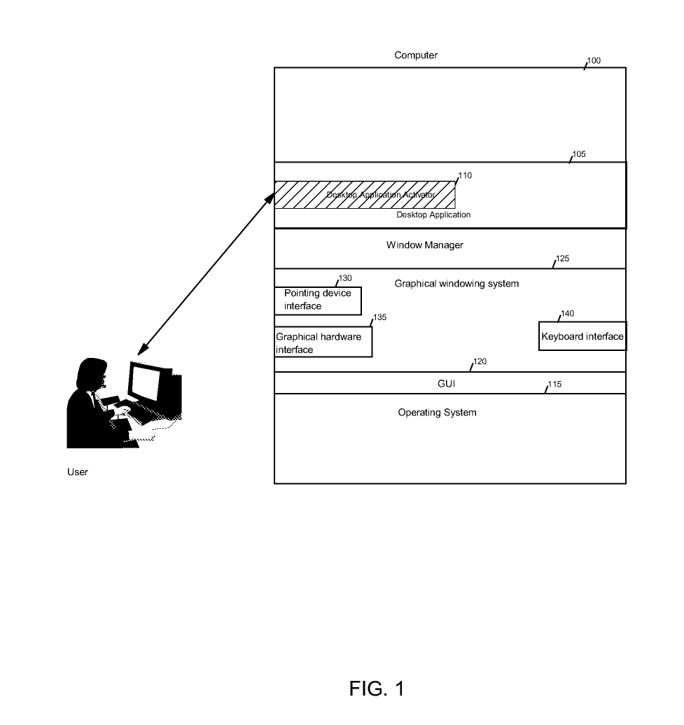

FIG. 1 illustrates an environment of an example of an implementation of the present subject matter and illustrates software blocks in a computer in which the present subject matter may be implemented as a new software layer. A computer (100) or intelligent device operating system (115) provides a graphical user interface (120). The graphical user interface (120) is used by a graphical windowing system (125). The graphical windowing system (125) allows windowing of applications using developed interfaces to a pointing device interface (130) (such as mouses, point-tracking devices, etc.), graphical hardware interfaces (135), and a keyboard interface (140). A window manager manages application windowing, such as minimizing etc. A window-based desktop application (105) allows the user to manage execution of applications through a graphical user interface in which applications are represented on the screen by icons. A desktop screen includes a center screen containing application icons corresponding to applications that the user has installed (by shortcut, drag and drop, etc., and desktop commands, etc.). The user clicks on an icon with the pointing device to start execution of an application. When an application has been started, its application icon is copied into a taskbar located in the screen frame and the user may open the window of this active application by clicking on this icon in the taskbar.

A new part of the desktop application as described herein, a Desktop Application Activator (110), implements the present subject matter for managing continuous multiple desktops. The Desktop Application Activator (110) modifies the traditional desktop view according to user settings. The implementation of the Desktop Application Activator (110) uses many system services that exist in the standard desktop application of the operating system (e.g., application icon management in the desktop view, in the active application taskbar, etc.). The Desktop Application Activator (110) uses new operating system services, such as percentage of transparency and other functionality described herein, which are part of the present subject matter.

The Desktop Application Activator (110) may be implemented as a plugin on the standard desktop application provided by the operating system (115). Any other type of extension of the code of the standard desktop application may be used, including replacement of the existing desktop application if the present subject matter is implemented in an operating system.

The Desktop Application Activator (110) may be automatically started in place of the standard desktop provided by the operating system when the user starts the desktop application. One other alternative would be to have this Desktop Application Activator (110) in replacement of the standard desktop application in the operating system.

It is noted that the present subject matter may also be implemented in hardware or other means known by a person skilled in the art based upon the description herein. However, in a preferred implementation, the present subject matter is implemented as a software program modifying the desktop application program of the operating system.

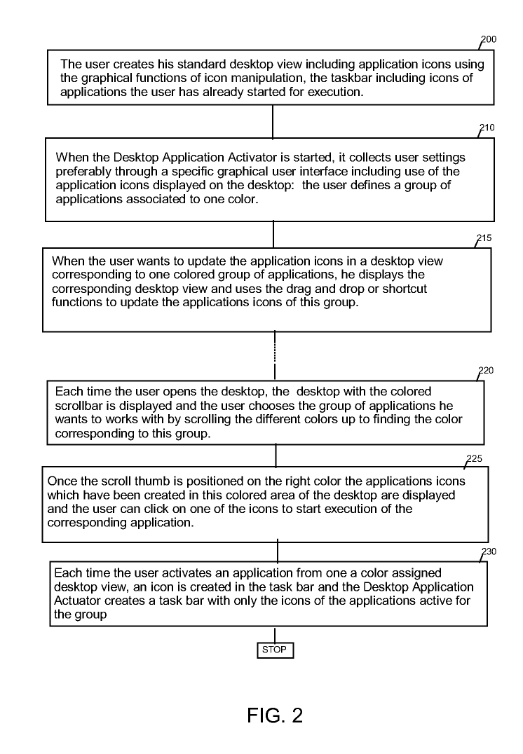

FIG. 2 is a flowchart of an example of an implementation of a process for implementing a user interface according to the present subject matter. A scrollbar may be used to allow the user to change the desktop while moving a cursor or scrollbar thumb in different colored areas represented as rectangles in the scrollbar. As described above, many pointing widgets such as a knob may be used for allowing the user to designate a different desktop. Also a desktop may be associated with one color or any other visual attribute such as a visual sign or drawing that the user will point to using the pointing widget. The pointing device and scrollbar may be permanently displayed or recalled by a tab for example on the desktop view. The pointed visual sign representing the current desktop in use may be continuously displayed as well. In the remainder of the description herein, a preferred embodiment with the use of a continuously displayed scrollbar and the use of color to designate a group of applications will be described.

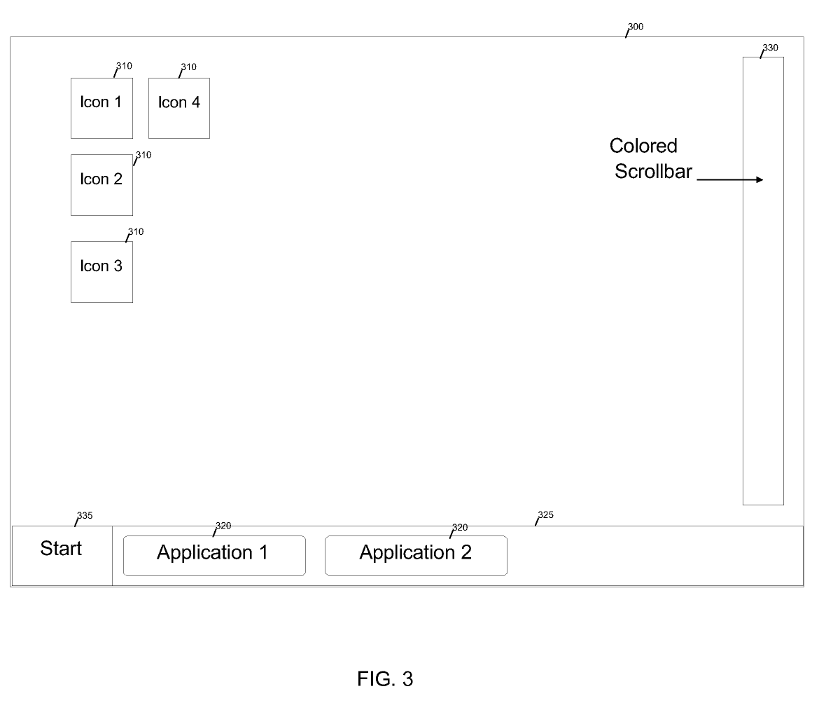

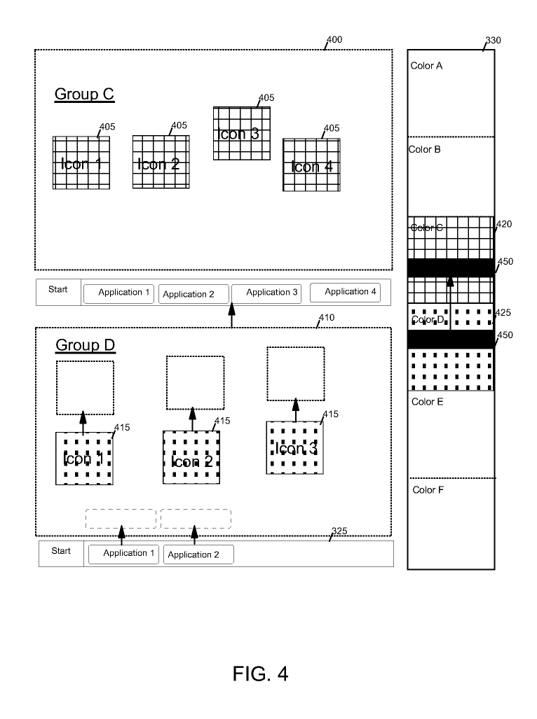

When the Desktop Application Activator (110) is active, a desktop view is displayed (200), which includes a central screen and a scrollbar in which the user may move the scroll thumb on different colored areas. This new view will be described in detail below in relation with the description of FIG. 3 and FIG. 4. It is assumed that the user has already created (200) a desktop view, with the standard desktop application by importing by usual drag and drop or shortcut creation, including application icons on the desktop view. It is also assumed that the user has already started execution of the standard desktop application from the operating system to manage execution from the desktop. At any time the user may execute the Desktop Application Activator (110) and may define the application icon grouping by color. The Desktop Application Activator (110), through a specific user interface, collects user settings (210), which include the colors of the different areas that will be contained in the colored scrollbar and user assignment of applications to each color of the colored areas. For choosing the application group color, the user clicks on the colors in a set of colors displayed by the Desktop Application Activator (110). When color selection is completed, a scrollbar containing colored areas corresponding to the selected colors is displayed preferably at the right side of the desktop view. Then, the user assigns a color to each application by successively clicking first a color in the scrollbar followed by an icon on the desktop view. It is noted that the user may choose an association between a color and a group of applications because some suites of applications may be represented by icons with a same prevailing color. Many different user interfaces may be developed in the Desktop Application Activator (110), all configured to collecting of user settings.

An alternative example scenario is when the user uses the desktop application with the Desktop Application Activator (110) running. In this case, to initialize desktop views, the user defines the different colored group (210), and may decide, for example, through the user settings configuration interface of the Desktop Application Activator (110), to create three groups. The three groups may include one blue group for development applications, one yellow group for collaborative applications, and one red group for one set of applications associated with a specific project the user is involved in. To populate the desktop view with the application icons, the user displays one desktop view associated with one color and by drag and drop or shortcut operations, the Desktop Application Activator (110) displays the application icons in this colored desktop view (215).

After the user settings are entered, the Desktop Application Activator (110) displays (220) a new desktop view displaying a scrollbar with colored areas preferably at the right side of the desktop view. The desktop view is a continuous desktop view in which the application icons displayed are those corresponding to the color of the colored area that the scroll thumb is pointing to in the colored scrollbar. The user may continuously display a new group of applications by moving the scroll thumb into a different colored area of the scrollbar (225). Also in the desktop view, only the application icons for running applications that are displayed in the taskbar may be the running applications of the group of applications that has been selected by the user.

At any time during a working session on the computer, the user when opening the desktop application window (220), activates the Desktop Application Activator (110) continuous desktop view that displays the different desktop views containing the different groups of applications. The user may choose the group of applications the user wants to works with by moving the scroll thumb in the different colored areas of the scrollbar to find the color corresponding to this group. Alternatively, the blue color may correspond, for example, to collaborative applications, and the user may have chosen in this group of applications the e-mail application, the text editor, spreadsheet editor, etc. The red color may correspond the applications for development purpose, etc. In the desktop corresponding to the chosen group of applications, the user may click on the application icon in the group of applications to start the corresponding application.

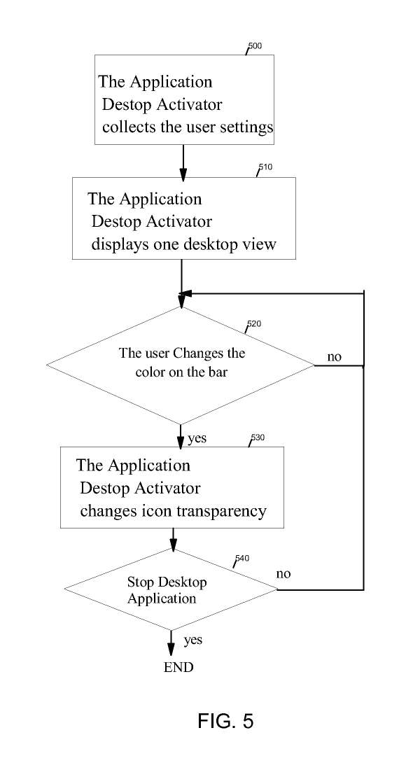

It is noted that the desktop view is preferably made continuous if, when the user points with the scroll thumb in an intermediate area between two colors, the desktop view change is made progressive from one view to one other view. As explained in more detail below, the techniques for changing of desktop views by making current application icons more and more transparent and the new application icons more and more opaque allows for such a continuous change. The transparency percentage is dependent on the position of the scrollbar thumb between two colors. If a color palette is used in the scrollbar, there are an infinite number of colors and the change appears more continuous on very small areas. An example of computation of percentage of transparency in relation with the movement of the cursor in a color palette is described in detail in relation with the description of FIG. 5.

The Desktop Application Activator (110) also manages the taskbar in which the icons of all the active applications in the system are displayed. A taskbar dedicated to each application group may be created by the Desktop Application Activator (110). When the user opens one color assigned desktop view, a specific taskbar is created and/or displayed (230) containing only the icons of applications active for the respective group. As described in more detail below, the user is always able to switch from the specific taskbar of the group to the system taskbar with all the applications active in the system.

The Desktop Application Activator (110) provides a quick way to navigate without disruption between the different desktop views by moving the scroll thumb in the colored scrollbar. It will be easy for the user to remember the association between a color and a group of applications, thus allowing better productivity for managing user applications in the user's personal computer.

FIG. 3 shows one static view of an example of an implementation of a desktop according to the present subject matter. In this static view one desktop view is shown corresponding to one group of applications comprising four (4) application icons (310) in the center of the screen on which the user may click to start the corresponding application. The desktop view may display a thumb to communicate directly with the operating system (Start button 335) to start programs not designated with an icon on the desktop or to stop the computer, etc. A new scrollbar (330) which is preferably vertical and displayed in the right side of the screen includes different color areas and is used by the user to navigate between the different desktop views, each desktop view, such as the one in FIG. 3, representing a group of applications associated to one color.

One variation to the steps for assigning colors to applications in the initialization or update steps 210 and 215 is when an additional function is provided by the Desktop Application Activator (110). By default a color may be assigned to one application uploaded by drag and drop of shortcut operations. The Desktop Application Activator (110) may identify a default color assigned to one application so that when the user uses a drag and drop or shortcut operation to upload the application icon to a desktop, the Desktop Application Activator (110) automatically assigns a default color, which is the prevailing color of the application icon, displays the corresponding color of the assigned desktop view, and displays in this desktop view the icon of this newly uploaded application. To perform this by default assignment, the Desktop Application Activator (110) identifies the prevailing color in the application icon. Algorithms and software tools capable of detecting the prevailing color of a visual object exist and are not described in detail herein. This default function of the Desktop Application Activator (110) allows initialization of the colors of groups of applications and initialization of the applications assigned to such application groups. At any time, the user may change the colors assigned by default by activating the user settings configuration interface (210) to define different colors and by assigning applications to different color assigned application groups (215).

When an application is activated, an icon is displayed in a taskbar (325) located on the screen frame, for example at the bottom of the screen. The taskbar (325) of the desktop view displays the application icons (320) of the applications of the group of applications already running. In FIG. 3, the desktop view displays the icons of a group of applications: Icon 1 being the icon of Application 1, Icon 2 being the icon of Application 2, etc. Application 1 and Application 2 being the only started applications of the group, the Desktop Application Activator (110) when updating the view of the application icons in the taskbar may rearrange and/or re-size the icons of the active applications displayed in the taskbar (325) for the group. The icons in the taskbar (325) containing the icons for all the applications active in the system corresponding to applications that do not belong to the group for which the desktop view is displayed become transparent and leave empty spots in the taskbar so that the icons may be gathered on a same side of the taskbar. Usually, the number of icons for all the applications active in the system is reduced. As such, the size of the icons when displaying only the icons for active applications in the group may be increased. To finish on the Desktop Application Activator (110) management of the taskbar, it is noted that the “complete taskbar” displaying the icons for all the applications active in the system may contain more than the icons of applications belonging to a color assigned desktop view managed by the Desktop Application Activator (110). The taskbar (325) for all active applications in the system may contain some icons which have not been displayed in any desktop view.

FIG. 4 illustrates an example of an implementation of the continuous desktop display in line with the movement of the cursor in the scrollbar according to the present subject matter. Particularly, FIG. 4 illustrates the change of view displayed from one desktop (410) to one other desktop (400). It is assumed that the desktop view displayed is the view for the Group D of applications within the desktop (410). It includes three (3) application icons (415) that the user may click on to start execution. This view has been chosen by the user who has moved the scroll thumb (450) in the scrollbar (330) in the colored area (425) of the scrollbar (330) corresponding to Group D (e.g., Color D). Preferably, the color of a group of applications will be the prevalent color of any or all of the applications in the group. The user may become readily familiar with the color of the group if the user is already familiar with the prevalent color of all the icons of the applications in the group.

When the user needs to work in a different application environment, for instance Group C of applications, the user moves the scroll thumb (450) in the colored scrollbar (330) from the Color D area (425) to the Color C area (420). As a result of this movement the Group D application icons (415) become transparent as represented by the dashed square boxes and the Group C application icons (405) are displayed so that the final desktop view is the Group C desktop view (400). In the same way, the application icons located in the taskbar (325) representing applications in Group D which are running, also become transparent as represented by the dashed rectangular boxes; then the application icons of applications running in Group C appear in the taskbar (325) by becoming opaque.

It is noted that, preferably, if the user selects an intermediate location of the scroll thumb which is in middle of “C” and “D” areas in the colored scrollbar (330), the user may see both Group D and Group C application icons with a different level of transparency. This possibility allows a real continuous display of the different desktops. As explained below, with a formula to compute percentage of transparency applied to the application icons, use is made of techniques that allow a visualized object to switch from opaque to transparent. These techniques also allow a continuous bi-directional switching of the visualized objects between opaque and transparent.

It is noted that the Desktop Application Activator (110) may be configured such that it does not allow a user to activate an application or open an application window of a running application unless the percentage of transparency is not greater, for example, than twenty percent (20%) (e.g., the icons are at least 80% opaque). This limit/threshold of percentage transparency is a configuration parameter of the application, it is variable but always greater than 0. As with the processing described above, only one desktop view is used by the Desktop Application Activator (110) for all of the application icons of all of the groups of applications, some of them being fully transparent with other ones being more or less opaque. This parameter prevents the user from clicking on a place of the desktop where no application icon is visibly displayed and activating the corresponding application associated with a transparent icon that would be displayed if this place was a place where an application icon with percentage of transparency 100% is displayed. This parameter is a ‘tolerance’ parameter that is the limit of transparency percentage or limit of application icon visibility: it may be chosen in accordance with the minimum acceptable visibility on the computer.

FIG. 5 is a general flowchart of an example of an implementation of a process that implements the present subject matter. In the first step, the Desktop Application Activator (110) collects the user settings (500), which are the different colors that the user wants to see displayed in the different colored areas of the scrollbar. The other user setting is the association between a color and a group of at least one application. There are two ways of collecting the association between a color and a group of at least one application. One way is the use the usual drag and drop or shortcut commands to populate the desktop view, changing the view and repeating the operation. Alternatively, collecting the application name and the color associated to an application group may be performed in a new user interface. The Desktop Application Activator (110) may collect the color information to associate application icons to a color in the scrollbar as the user clicks on a color area inside a displayed set of colors and clicks on the icons displayed on the desktop that will belong to the same group associated to this color. Preferably, the same dialog is performed to associate a color to the applications that are in execution and for which the icons are displayed in the taskbar. The user clicks on a color area in the scrollbar and then clicks on the application icons displayed in the taskbar. If the user does not want to start from a standard desktop view before activating the Desktop Application Activator (110), the other way to initialize the desktop views is to first choose new colored groups by choosing colors in a palette so that the Desktop Application Activator (110) creates empty desktop views. Then in each desktop view that the user displays by moving the scrollbar thumb in the corresponding colored area of the scrollbar, the user may drag and drop or create shortcuts to applications so that the corresponding icons are displayed in the desktop view that is displayed.

It is assumed that the Desktop Application Activator (110) displays a desktop view (510) including the colored scrollbar as defined by the user settings, and that the desktop view displays the application icons of the group of applications associated with the color in the scrollbar pointed to by the scroll thumb (450). If the user moves the scroll thumb (450) in the scrollbar (330) into a new colored area, the user designates a new group of applications (answer yes to test 520), the Desktop Application Activator (110) receiving this information displays the desktop view corresponding to this group of applications. To perform a switching of desktop views, the Desktop Application Activator (110) makes the icons previously displayed transparent (530) and makes the icons of the new desktop which were not visible opaque, that is fully displaying the icon so that the user sees a switching of desktop. This is performed by the Desktop Application Activator (110) applying transparency methods as available in most of the operating systems. It is possible to assign a percentage of transparency to one object to be displayed. A percentage of transparency may be applied to each application icon displayed by the Desktop Application Activator (110). This operating system service may apply an algorithm, such as alpha compositing, to which a color associated with each pixel of an image is added a transparency value, which may vary from zero to one (0 to 1). When the transparency value is zero (0) the pixel has the full opaque color and when the transparency value is one (1) the pixel is transparent. It is noted that using such algorithms, switching from opaque to transparent and transparent to opaque may be performed continuously by applying a progressive increasing or decreasing percentage of transparency value. When the user moves the scrollbar thumb (450) into different colored areas, the Desktop Application Activator (110) follows the color changes through all the areas by switching continuously from one desktop view to another desktop view making the disappearing icons more and more transparent and the appearing icons more and more opaque.

The Desktop Application Activator (110), when refreshing the taskbar with activated application icons from one group to another group, obtains the visual effect in the same way. The taskbar management by the Desktop Application Activator (110) is done with the same transparency methods as described herein.

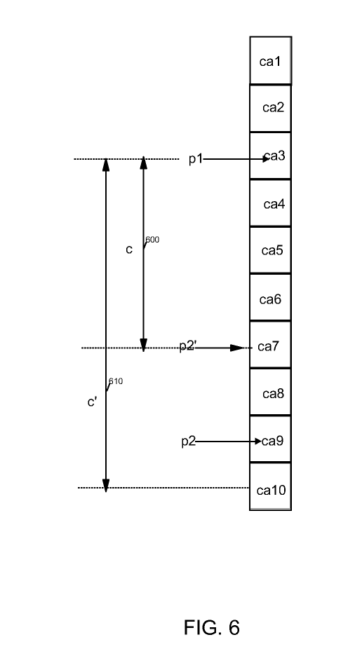

To switch continuously from one desktop view to another desktop view, the percentage of transparency may be changed progressively while the user moves the scrollbar thumb in the scrollbar (330). One example of an algorithm to switch continuously from one desktop view to another desktop view is illustrated in FIG. 6 described below.

At the same time that the Desktop Application Activator (110) applies the percentage of transparency (T) to the icons of the initial desktop view (and the corresponding taskbar), the application icons become transparent. The Desktop Application Activator (110) applies the percentage of transparency as one hundred minus “T” (e.g., 100−T) to the icons (of the central desktop view and the taskbar) corresponding to the new group of applications associated with the new color pointed out by the scroll thumb (450) in the colored scrollbar (330), which appear and form the new desktop view.

At the end of the execution of the step (530), the new icons corresponding to the group of applications associated with the color pointed out by the scroll thumb (450) in the scrollbar (330) are displayed on the desktop. The desktop has been switched in a continuous way from one group of applications to another group of applications corresponding to one different choice of color by the user.

By a click and move of the user pointing device, the Desktop Application Activator (110) switches in a continuous way from one desktop to another desktop (530) until the user stops the desktop application (answer yes to test 540).

It is noted that the number of groups of applications and the association with a color may be as numerous the user desires, the only limitation being the computer memory size. This means that an unlimited number of groups of applications may be associated to a specific color and the desktop may be continuously changed an unlimited number of times.

It is noted also that a same application may be included in different groups. This provides a great flexibility in application classifications.

FIG. 6 illustrates one example of an implementation of computation for a progressive change of percentage of transparency applied to the application icons according to the present subject matter. Within FIG. 6, “ca1” represents colored area one (1) through “ca8” that represents colored area eight (8). Assuming the user moves from one current position “p1” in the scrollbar in relation with a given color (“ca3” is for colored area 3) to one new position “p2” in the scrollbar corresponding to one different color (“ca7” for colored area 7), the computer calculates the percentage of transparency of the application icons of the new position “p2” in the central desktop view and in the taskbar as follows:

Assuming “c” is a constant value (defined as a visual parameter when configuring the Desktop Application Activator (110)), which may be chosen by the user:

Tₚ₂=d(p1,p2)/c*100 if c>d(p1,p2)

Tₚ₂=100 if c=<d(p1,p2)

Tₚ₁=100−Tₚ₂

where:
“Tₚ₂” is the percentage of transparency computed at position “p2,” and “Tₚ₁” is the percentage of transparency computed at position “p1;”
“d(p1,p2)” is the distance between the two (2) colors at “p1” and “p2” physically measured in the scrollbar in proportion to the constant “c;”
“p1” is the current color selected by the user in the scrollbar;
“p2” is the next color that the user just points to in the scrollbar;
if p1=p2 d(p1,p2)=0 and Tₚ₁=Tₚ₂,0%

Using the illustration of the formula in FIG. 6, in the first case (600) where the distance is less than “c” (d<c), when the scrollbar thumb (450) is in the position p1, the transparency percentage value is zero percent (0%) and the application icons of the color area “ca1” are fully opaque, while the transparency percentage value of the application icons of the color area “ca9” is one hundred percent (100%) and the icons of the color area “ca9” are fully transparent. In position p2 prime (p2′), the application icons of the color area “ca9” are already fully opaque as their transparency percentage is zero percent (T_{p2′}=0%). At this point also the transparency percentage of the application icons of the position p1 is one hundred percent (100%) and the icons are fully transparent (T_{p2′}=0% and Tₚ₁=100%). At a position between p2′ and p2, the transparency percentage of the application icons of the position p1 is one hundred percent (100%) and the icons are fully transparent (T_{p2′}=0% and Tₚ₁=100%). Also, at a point between p1 and p2′ the transparency percentage of the application icons of the group corresponding to pointed colored area is progressively increased from zero to one hundred percent (0% to 100%) in proportion to the ratio to c (Tₚ₂=d(p1,p2)/c*100). Symmetrically, at this point between p1 and p2′ the transparency percentage of the application icon of the group corresponding to colored area “ca1” is progressively increased from zero to one hundred percent (0% to 100%) in proportion to the ratio to c (Tₚ₁=100−d(p1,p2)/c*100).

In the second case (610) where the distance is greater than “c” prime (d>=c′), when the scrollbar thumb is in the position p1, the transparency percentage is zero percent (0%) and the application icons of the color area “ca1” are fully opaque, while the transparency percentage of the application icons of the color area “ca9” is one hundred percent (100%) and the icons of the color area “ca9” are fully transparent. When moving from the position p1 to p2, the transparency percentage of the application icon of the group corresponding to pointed colored area “ca8” is progressively increased from zero to one hundred percent (0% to 100%) in proportion to the ratio to c (Tₚ₂=d(p1,p2)/c*100). Symmetrically, the transparency percentage of the application icon of the group corresponding to colored area “ca1” is progressively increased from zero to one hundred percent (0% to 100%) in proportion to the ratio to c (Tₚ₁=100−d(p1,p2)/c*100).

The constant “c” is defined as a range of progressive change of percentage of transparency. It is defined as a physical measure on the scrollbar (in number of centimeters for example) and the distance between two positions in the scrollbar d(p1,p2) is always a proportion of the constant “c.” If the constant “c” is a small value, the range of progressive change of percentage of transparency from the initial position to a new position is for new positions in a small area in the scrollbar. With the use of the “c” constant configuration parameter, the switching of transparency percentage applied to the application icons from one colored area to another colored area is not done from zero to one hundred percent (0% to 100%) and from one hundred to zero percent (100% to 0%), but at a progressive value greater than zero percent (0%) and less than one hundred percent (100%).

In one example, the scrollbar includes a color palette with a quasi infinite number of colors. Using a color palette allows a determination of a quasi-infinite number of groups of applications. Within this example, the scrollbar thumb (450) may be a cursor because the color areas in this case are very thin. The same calculation is performed by the computer to determine the percentage of transparency to be assigned to all the application icons of the desktop. When a color palette is used, the calculation of the distance between two points in the color palette may be performed by the computer in the way already described by identifying the two locations of positions p1 and p2 in the scrollbar corresponding to the movement of the cursor by the user to designate a new group of applications in the scrollbar, and computing the physical distance d(p1,p2) on the screen. When using a color palette in the scrollbar, the distance may also be calculated by the computer with an algorithm for computing a distance between two colors in a color palette, such as a color difference algorithm.

However, once the distance is computed, the percentage of transparency may be calculated in the same way:

Tₚ₂=d(p1,p2)/c*100 if c>d(p1,p2)

Tₚ₂=100 if c=<d(p1,p2)

Tₚ₁=100−Tₚ₂

It is noted that in a preferred embodiment, for calculating the distance between two points in the scrollbar and the percentage of transparency of the application icons, the computer may take into account the current and new position in the scrollbar, which means that only the application icons corresponding to the current and new colored areas are displayed. More particularly, all the application icons corresponding to the colored areas different from the current and new position, even those which are intermediate in the scrollbar between the two positions, remains with a transparency percentage of one hundred percent (100%). One other possibility includes displaying all the intermediate application icons in the other colors with a variable level of transparency so that the application icons appear and disappear with the movement of the cursor in the scrollbar. However, this may not provide as much benefit if a color palette is used.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
associating, via a computing system, a transparency percentage value with each application icon defined for active executable applications;
collecting from a user at least two differentiating visual attribute values and collecting, for each different visual attribute value, at least one application that is active on a desktop screen;
displaying the different collected visual attribute values and a pointing widget that allows the user to designate one of the different visual attribute values;
displaying the icons of the at least one application collected for each different visual attribute value using a transparency percentage value of zero percent (0%) for each application icon of the at least one application corresponding to the visual attribute value currently pointed to by the pointing widget and a transparency percentage value of one hundred percent (100%) for at least one other application icon corresponding to at least one visual attribute value that is not currently pointed to by the pointing widget; and
in response to detecting a change by the user from a current visual attribute value pointed to by the pointing widget to a different new visual attribute value pointed to by the pointing widget, adjusting the transparency percentage values of the application icons based upon the new visual attribute value pointed to by the pointing widget.

2. The method of claim 1 wherein the visual attribute values are colors and the pointing widget is a scrollbar thumb moving in a scrollbar, and where:
collecting from the user the at least two differentiating visual attribute values and collecting, for each different visual attribute value, the at least one application that is active on the desktop screen comprises:
collecting from the user at least two colors and collecting, for each color, at least one application that is active on the desktop screen;
displaying the different collected visual attribute values and the pointing widget that allows the user to designate the one of the different visual attribute values comprises:
displaying the scrollbar in which colored areas correspond to the at least two collected colors, where the user can move the scrollbar thumb relative to the scrollbar;
displaying the icons of the at least one application collected for each different visual attribute value using the transparency percentage value of zero percent (0%) for each application icon of the at least one application corresponding to the visual attribute value currently pointed to by the pointing widget and the transparency percentage value of one hundred percent (100%) for the at least one other application icon corresponding to the at least one visual attribute value that is not currently pointed to by the pointing widget comprises:
displaying the icons of the at least one application collected for each different color using the transparency percentage value of zero percent (0%) for each application icon of the at least one application corresponding to the color of the colored area currently pointed to by the scrollbar thumb in the scrollbar and the transparency percentage value of one hundred percent (100%) for the at least one other application icon corresponding to at least one color that is not currently pointed to by the scrollbar thumb; and
in response to detecting the change by the user from the current visual attribute value pointed to by the pointing widget to the different new visual attribute value pointed to by the pointing widget, adjusting the transparency percentage values of the application icons based upon the new visual attribute value pointed to by the pointing widget comprises:
in response to detecting a move by the user of the scrollbar thumb in the scrollbar into one different colored area, adjusting the transparency percentage values of the application icons based upon the new color pointed to by the scrollbar thumb.

3. The method of claim 2, where displaying the icons of the at least one application collected for each different color comprises:
displaying at one edge of the desktop screen a desktop taskbar within a desktop environment; and
displaying in the desktop taskbar the icons of the at least one application collected for each different color that are currently running using the transparency percentage value of zero percent (0%) for each application of the at least one application corresponding to the color of the colored area pointed to by the scrollbar thumb in the scrollbar and the transparency percentage value of one hundred percent (100%) for the at least one other application icon corresponding to at least one color that is not currently pointed to by the scrollbar thumb.

4. The method of claim 2, further comprising:
displaying, in response to detecting the user starting execution of an application by clicking on an icon that corresponds to the started application among the icons displayed for the at least one application corresponding to the color of the colored area pointed to by the scrollbar thumb in the scrollbar, in the desktop taskbar the icon that corresponds to the started application with the transparency percentage value of zero percent (0%).

5. The method claim 2, where the collecting from the user the at least two colors is replaced by:
automatically computing a prevailing color of each icon defined for the at least one application that is active on the desktop screen; and
forming, for each computed prevailing color, a set of at least one application with icons that comprise the computed prevailing color.

6. The method claim 2, further comprising:
activating an application in response to detection of the user clicking on an application icon only if the application icon is displayed with a transparency percentage value not greater than a maximum configuration percentage value represented by a variable “m” percent (m %), “m” being greater than zero.

7. The method claim 2, where the transparency percentage value of zero percent (0%) is accepted to be not greater than a constant configuration percentage value of “k” percent (k %) and the transparency percentage value of one hundred percent (100%) is accepted to be equal to or not greater than a constant configuration parameter percentage value of (100−k) %.

8. The method of claim 2, where the transparency percentage values applied to the application icons when the user moves the scrollbar thumb from a first point (p1) of a color palette in the scrollbar to a second point (p2) of the color palette in the scrollbar depends on a physical distance d(p1,p2) in the scrollbar between the two points.

9. The method of claim 8, where transparency percentage values applied to application icons of applications associated with the second point (p2) of the color palette in the scrollbar when the user moves the cursor from the first point (p1) to the second point (p2) in the scrollbar comprises:
Tp2=(d(p1,p2)/C)*100, when d(p1,p2)>c and
Tp2=100 when d(p1,p2)> or =c;
c being a constant configuration value.

10. The method claim 2, where the scrollbar contains a color palette and the scrollbar thumb comprises a cursor.

11. A system comprising means adapted to carry out the steps of the method according to claim 1.

12. A computer program product comprising stored instructions for carrying out the steps of the method according to claim 1 when said computer program product is executed on a computer.
